(19) United States
(12) Patent Application Publication
(10) Pub. No.: US 2023/0035994 A1
(43) Pub. Date: Feb. 2, 2023

(54) TERMINAL AND COMMUNICATION METHOD

(71) Applicant: NTT DOCOMO, INC., Tokyo (JP)

(72) Inventors: Takuma Takada, Chiyoda-ku, Tokyo (JP); Hideaki Takahashi, Chiyoda-ku, Tokyo (JP)

(73) Assignee: NTT DOCOMO, INC., Tokyo (JP)

(21) Appl. No.: 17/791,715

(22) PCT Filed: Feb. 13, 2020
(86) PCT No.: PCT/JP2020/005675

§ 371 Date: Jul. 8, 2022

(51) Int. Cl. H04W 24/10; H04W 8/22

(52) U.S. Cl. CPC H04W 24/10; H04W 8/22

(57) ABSTRACT

A terminal includes, a reception unit configured to receive a configuration regarding measurement from a base station, a control unit configurated to execute measurement based on the configuration regarding the measurement, and a transmission unit configured to transmit a result of the executed measurement to the base station, wherein the control unit is configured to identify a measurement execution interval based on the configuration regarding the measurement, and to configure a communication interruption period, at a head and a tail of the measurement execution interval, in accordance with a capability of the terminal.

### TECHNICAL FIELD

The present invention relates to a terminal and a communication method in a radio communication system.

### BACKGROUND ART

In NR (New Radio) (also referred to as “5G”), which is the successor system of LTE (Long Term Evolution), techniques for satisfying, as required conditions, a large capacity system, a high data transmission speed, low latency, simultaneous connection of numerous terminals, low cost, power saving, and the like are being studied (See Non-Patent Document 1).

In an LTE radio communication system, in a case where a terminal that supports carrier aggregation in which multiple frequency bands are used is implemented by a single RF circuit, it is necessary to configure a measurement gap in order to execute inter-frequency measurement. The length of a measurement gap in conventional technology is typically configured to 6 ms, and during this period the terminal cannot receive downlink data. Moreover, if a period for Hybrid Automatic Repeat Request (HARQ) feedback of ACK/NACK to be returned after 4 ms for transmitted data is reserved, the period of 4 ms preceding the measurement gap is substantially unusable for transmitting the downlink data. There also is a period during which uplink data is unusable, and in a case where the method is Frequency Division Duplex (FDD), the terminal cannot transmit uplink data during the measurement gap period of 6 ms and during the period of 1 ms subsequent to the measurement gap.

As one solution to shorten the period during which transmission is unavailable as described above, in an LTE radio communication system, Network Controlled Small Gap (NCSG) has been implemented as a small gap with a smaller period than that in conventional technology (Non-Patent Document 2, for example). With small gap measurement, in the first two subframes and the last two subframes of an existing measurement gap, the terminal interrupts communication with a camped base station so as to measure another cell targeted for inter-frequency measurement and executes preparation operations for inter-frequency measurement such as an adjustment of the RF circuit. In subframes sandwiched between these two subframes, the inter-frequency measurement is executed and downlink data is received from the camped base station.

### RELATED ART DOCUMENT

### Non-Patent Document

Non-Patent Document 1: 3GPP TS 38.300 V15.8.0 (2019-12)
Non-Patent Document 2: 3GPP TS 36.133 V15.9.0 (2019-12)

### SUMMARY OF THE INVENTION

### Problem to be Solved by the Invention

In a case where a function similar to NCSG of LTE is to be deployed in NR, it is necessary to take into account the unique configuration of NR and to determine a communication interruption period that is necessary for inter-frequency measurement.

The present invention has been made in view of the above, and it is an object of the present invention to execute inter-frequency measurement during a communication interruption period to be configured by the terminal in accordance with an environment, in a radio communication system.

### Means for Solving Problem

According to the disclosed technique, provided is a terminal that includes A terminal includes, a reception unit configured to receive a configuration regarding measurement from a base station, a control unit configurated to execute measurement based on the configuration regarding the measurement, and a transmission unit configured to transmit a result of the executed measurement to the base station, wherein the control unit is configured to identify a measurement execution interval based on the configuration regarding the measurement, and to configure a communication interruption period, at a head and a tail of the measurement execution interval, in accordance with a capability of the terminal.

### Effect of the Invention

According to the disclosed technique, in the radio communication system, inter-frequency measurement during a communication interruption period that is to be configured by the terminal in accordance with an environment can be executed.

### BRIEF DESCRIPTION OF DRAWINGS

FIG. 1 is a diagram for describing a radio communication system according to an embodiment of the present invention;

FIG. 2 is a sequence diagram for describing an operation example according to the embodiment of the present invention;

FIG. 3 is a diagram illustrating an example (1) of measurement;

FIG. 4 is a diagram illustrating an example (2) of measurement;

FIG. 5 is a diagram illustrating an example (3) of measurement;

FIG. 6 is a diagram illustrating an example (1) of measurement according to the embodiment of the present invention;

FIG. 7 is a diagram illustrating an example (2) of measurement according to the embodiment of the present invention;

FIG. 8 is a diagram illustrating an example (3) of measurement according to the embodiment of the present invention;

FIG. 9 is a diagram illustrating an example (4) of measurement according to the embodiment of the present invention;

FIG. 10 is a diagram illustrating an example (5) of measurement according to the embodiment of the present invention;

FIG. 11 is a diagram illustrating an example (6) of measurement according to the embodiment of the present invention;

FIG. 12 is diagram illustrating an example of a functional configuration of a base station 10 according to the embodiment of the present invention;

FIG. 13 is a diagram illustrating an example of a functional configuration of a terminal 20 according to the embodiment of the present invention; and

FIG. 14 is a diagram illustrating an example of a hardware configuration of the base station 10 and the terminal 20 according to the embodiment of the present invention.

### MODE FOR CARRYING OUT THE INVENTION

An embodiment of the present invention will be hereinafter described with reference to the drawings. The embodiment described below is an example, and the embodiment to which the present invention is applied is not limited to the following embodiment.

In operation of a radio communication system according to embodiment of the present invention, existing techniques are used as appropriate. However, an example of existing technique includes an existing LTE, but is not limited to the existing LTE. In addition, the term “LTE” used in this specification has a broad meaning including LTE-Advanced and specifications newer than LTE-Advanced (e.g., NR) unless otherwise specified.

In the embodiments of the present invention described below, terms such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), and the like used in the existing LTE are used. This is for convenience of description, and signals, functions, and the like may be referred to as other names. In NR, the above terms correspond to NR-SS, NR-PSS, NR-SSS, NR-PBCH, NR-PRACH, NR-PDCCH, NR-PDSCH, NR-PUCCH, NR-PUSCH, and the like. However, even when signals are used for NR, “NR-” is not necessarily attached thereto.

In the embodiments of the present invention, the duplex method may be a TDD (Time Division Duplex) method, an FDD (Frequency Division Duplex) method, or others (for example, Flexible Duplex and the like).

Further, in the embodiment of the present invention, “to configure” a radio parameter or the like may mean that a predetermined value is configured in advance (Pre-configured), or that a radio parameter indicated by a base station 10 or a terminal 20 is configured.

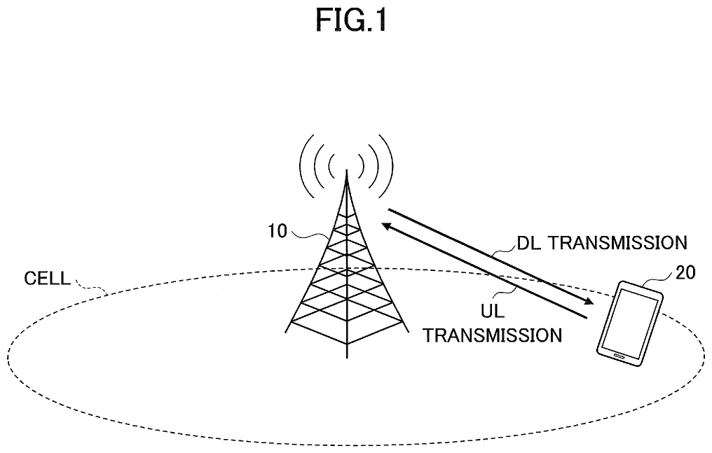

FIG. 1 is a diagram for describing a radio communication system according to the embodiment of the present invention. As illustrated in FIG. 1, a radio communication system according to an embodiment of the present invention includes a base station 10 and a terminal 20. In FIG. 1, one base station 10 and one terminal 20 are illustrated, but this is only an example. Alternatively, a plurality of base stations 10 and terminals 20 may be provided.

The base station 10 provides one or more cells, and is a communication apparatus that wirelessly communicates with the terminal 20. The physical resource of a radio signal is defined in the time domain and the frequency domain. The time domain may be defined by OFDM symbol number. The frequency domain may be defined by the number of subcarriers or the number of resource blocks. The base station 10 transmits a synchronization signal and system information to the terminal 20. The synchronization signal is, for example, NR-PSS and NR-SSS. The system information is transmitted in, for example, NR-PBCH, and is also referred to as broadcast information. As illustrated in FIG. 1, the base station 10 transmits a control signal or data to the terminal 20 through DL (Downlink), and receives a control signal or data from the terminal 20 through UL (Uplink). Both the base station 10 and the terminal 20 can transmit and receive signals by performing beamforming. Both of the base station 10 and the terminal 20 can apply communication based on MIMO (Multiple Input Multiple Output) to DL or UL. Also, both of the base station 10 and the terminal 20 may perform communication via a secondary cell (SCell) with CA (Carrier Aggregation) and a primary cell (PCell). Further, the terminal 20 may perform communication via a primary cell of the base station 10 and a primary secondary cell (PSCell) of another base station 10 with dual connectivity (DC).

The terminal 20 is a communication apparatus equipped with a wireless communication function such as a smartphone, a mobile phone, a tablet, a wearable terminal, and a communication module for M2M (Machine-to-Machine). As illustrated in FIG. 1, the terminal 20 receives control signals or data from the base station 10 in DL, and transmits control signals or data to the base station 10 in UL, thereby using various communication services provided by the radio communication system.

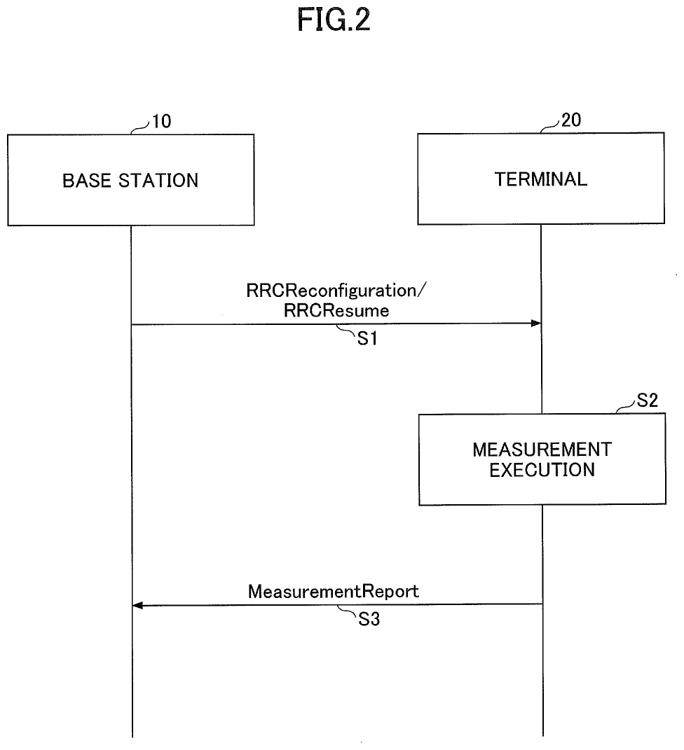

FIG. 2 is a diagram for describing a radio communication system according to the embodiment of the present invention. An example for executing inter-frequency measurement in NR is described with reference to FIG. 2.

In step S1, the base station 10 transmits a Radio Resource Control (RCC) message that is either “RRCReconfiguration” or “RRCResume” is transmitted to the terminal 20. The “RRCReconfiguration” is an RRC message for performing an RRC connection change. The “RRCResume” is an RRC message for performing resumption of an RRC connection that was temporarily idled. The RRCReconfiguration” or the “RRCResume” may include an information element “MeasObjectNR” for performing a configuration regarding measurement.

The “MeasObjectNR” may include information for inter-frequency measurement using SSB or Channel State Information—Reference Signal (CSI-RS). For example, the “MeasObjectNR” includes an information element “SSB-MTC” and an information element “SSB-MTC2” regarding configuration of SMTC (SSB(SS/PBCH block) Measurement Timing Configuration) that is a window for measuring SSB. Also, the “MeasObjectNR” may include information that identifies a measurement execution interval.

Here, in a case where the terminal 20 executes inter-frequency measurement, the terminal 20 configures a measurement gap, suspends data transmission and reception of all serving cells, and performs RF re-tuning to the frequency within the measurement gap and performs measurement.

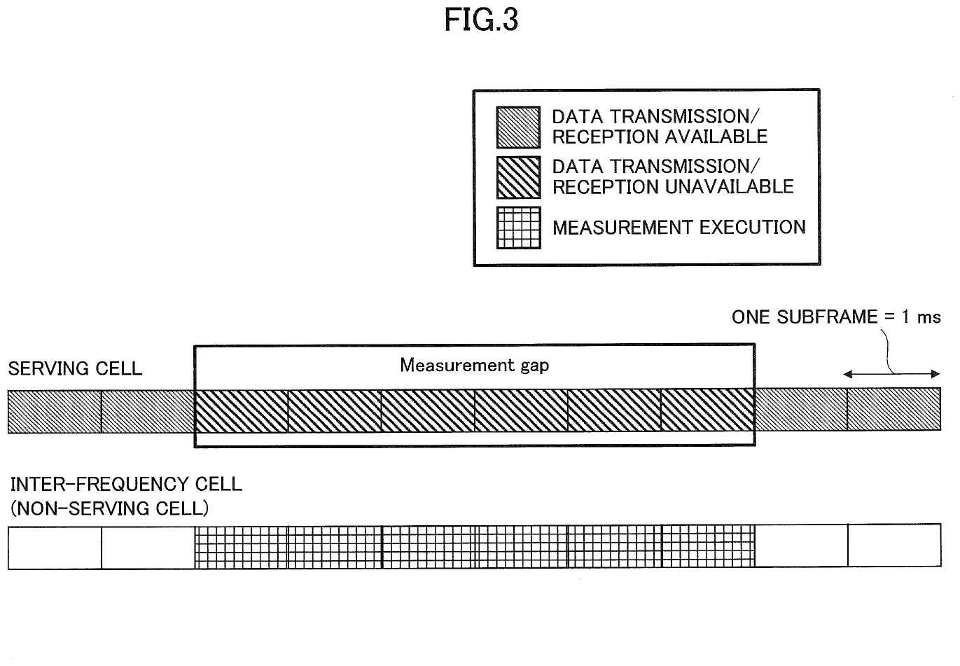

FIG. 3 is a diagram illustrating an example (1) of measurement. As illustrated in FIG. 3, in LTE, a measurement gap of six subframes is configured and an inter-frequency cell that is a non-serving cell is measured. As illustrated in FIG. 3, data transmission and reception are not available in the serving cell within the measurement gap. It is to be noted that one subframe may be 1 ms.

However, depending on the RF circuit configuration of the terminal 20, there is a possibility that inter-frequency measurement can be executed without configuring a measurement gap and without impacting communication of a serving cell.

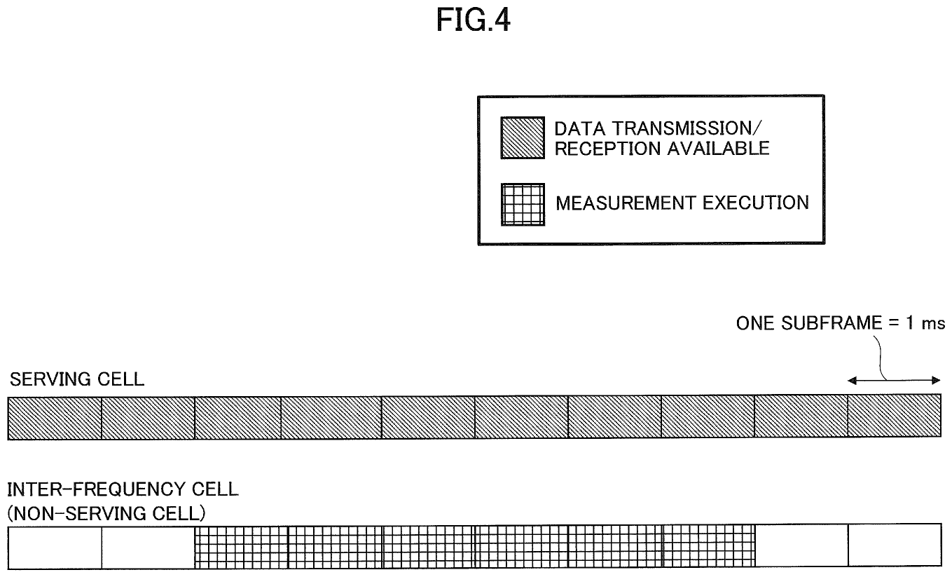

FIG. 4 is a diagram illustrating an example (2) of measurement. As illustrated in FIG. 4, the terminal 20 can measure an inter-frequency cell, which is a non-serving cell, without a measurement gap. In the case of LTE, the terminal 20 can indicate, to the base station 10, whether or not a measurement gap is necessary for performing inter-frequency cell measurement as UE Capability by using an information element “interFreqNeedForGaps” in accordance with a band.

Furthermore, as described above, a Network Controlled Small Gap (NCSG) for LTE has been deployed. With NCSG, a transmission and reception interruption can be triggered for a small period (1 ms or 2 ms, for example) transmission and reception interruption transmission at the head and at the tail of the measurement gap used prior to deployment of NCSG (6 ms, for example), thereby enabling data scheduling within the remaining period. The transmission and reception interruption period may be called a small gap. The “small gap” may be referred to as a “communication interruption period” or “interruption”. The terminal 20 that supports NCSG may indicate, to the base station 10, the information element “ncsg-r14” as the UE capability. The terminal 20 that supports NCSG can execute inter-frequency measurement by configuring an interruption at the beginning of the measurement gap and an interruption at the end of the measurement gap.

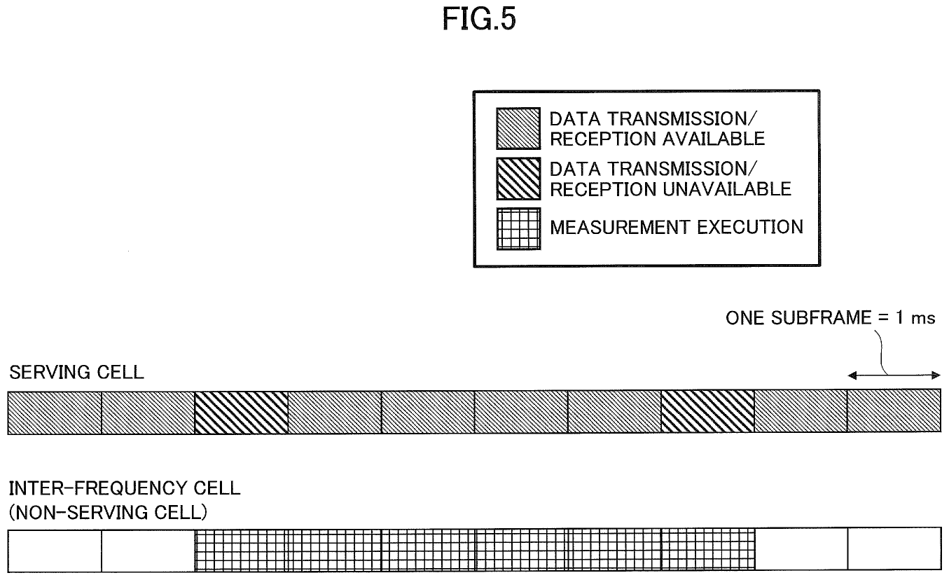

FIG. 5 is a diagram illustrating an example (3) of measurement. As illustrated in FIG. 5, the terminal 20 can perform measurement of an inter-frequency cell that is a non-serving cell by configuring an interruption requiring one subframe at the start of measurement and configuring an interruption requiring one subframe at the end of the measurement. In the serving cell, data transmission and reception are available in the subframes where no interruption is placed.

In NR, as in LTE, cases where measurement can be performed without the need for a measurement gap, that is, the necessity for specifying UE capability equivalent to the information element “interFreqNeedForGaps” and the deployment of interruptions, are being studied.

In a case where a function similar to NCSG is to be deployed in NR, when configuring an interruption, it is necessary to take into account the following factors 1) to 4) that are different from LTE.

1) In a case where the SubCarrier Spacing (SCS) of the serving cell and the inter-frequency cell are different.

2) In a case where the Frequency Range (FR) of the serving cell and the inter-frequency cell are different. Furthermore, in a case where the terminal 20 supports per-FR gap (the gap of FR1 and the FR2 can be configured independently of each other in a case where inter-frequency measurement is executed at FR1 and FR2).

3) In a case of EUTRA-NR dual connectivity (EN-DC) or NR-EUTRA dual connectivity (NE-DC).

Furthermore, in a case where the Radio Access Technologies (RAT) are asynchronous.

4. Relevance to SMTC. In a case of NR, when a terminal is to be made to execute measurement using SSB, a measurement gap length is not necessarily assumed because an SMTC is indicating in addition to the measurement gap.

In order to address these, the occurrence conditions, the length, and position of the interruption that may potentially occur in a case where inter-frequency measurement is executed without a measurement gap, are clarified, and thus effective utilization of radio resources is achieved. For example, the deployment of gapless inter-frequency measurement is specified and technical specifications and the occurrence conditions of interruption are specified.

In a case where interruption occurs during gapless inter-frequency measurement and the SCS of the serving cell and the inter-frequency cell are the same, an interruption that comes at the beginning and comes at the end of the set SMTC of the measurement gap may be set to occur for 0.5 ms if both cells are in FR1, or may be set to occur for 0.25 ms if both cells are in FR2. The interruption corresponds to the duration of RF re-tuning. The interruption may be named or specified as a slot length or a symbol length.

The value of the length or the occurrence position of the interruption may be modified in accordance with the support conditions for per-UE gap or per-FR gap. The per-UE gap refers to the UE capability in which the same measurement gap is necessary in FR1 and in FR2 in a case where inter-frequency measurement is to be executed in FR1 or FR2.

For example, in a case where a terminal 20 supports per-UE gap, all the interruptions may be set to 0.5 ms and the interruptions may be configured so as to occur in all of the serving cells. Conversely, in a case where a terminal 20 supports per-FR gap, if a serving cell and the measurement cell are both in FR1, the interruptions may be set to 0.5 ms, so as not to impact the serving cell in FR2. Further, in a case where a terminal 20 supports per-FR gap and a serving cell and the measurement cell are both in FR2, the interruptions may be set to 0.25 ms, so as not to impact the serving cell in FR1. The interruption corresponds to the duration of the RF re-tuning time. The interruption may be named or specified as a slot length or a symbol length.

Also, in a case where there are different SCSs, the interruption at the beginning and the interruption at the end of the set SMTC or the measurement gap may be set to occur for 0.5 ms if a serving cell and the measurement cell are both in FR1, or may be set to occur for 0.25 ms if a serving cell and the measurement cell are both in FR2. The interruption corresponds with the duration of the RF re-tuning time. The interruption may be named or specified as a slot length or a symbol length.

In a case where gapless inter-frequency measurement is executed in cells in different FR, the value of the length of the interruption or the occurrence position of the interruption may be modified. For example, in a case where a terminal 20 supports the per-UE gap, all the interruptions may be set to 0.5 ms and the interruptions may be configured so as to occur in all of the serving cells. That is, the interruptions in the FRs with the low frequencies may be configured so as to occur at the same time.

In contrast to this, in the case of a terminal 20 that supports the per-FR gap, if the measurement cell is FR1, the interruptions may be set to 0.5 ms so as not to impact the serving cell in FR2. Alternatively, in the case where a terminal 20 supports per-FR gap, if the measurement cell is in FR2, the interruptions may be set to 0.25 ms so as not to impact the serving cell in FR1.

In a case where interruption occurs during gapless inter-frequency measurement, if the serving cell and the inter-frequency cell are asynchronous, extending the length of the interruption by one slot may be allowed. That is, the extending of the interruption may be performed by adding a slot to the interruption.

Also, taking into account timing advance, in a case where the UL slot comes immediately after the interval at which gapless inter-frequency measurement is executed because the UL timing of the serving cell comes before the timing at which the measurement gap ends and because the UL slot immediately after the gap overlaps with the measurement interval, the interruption that comes immediately after the measurement execution interval may be allowed to be extended by one slot. That is, the extending of the interruption may be performed by adding a slot to the interruption.

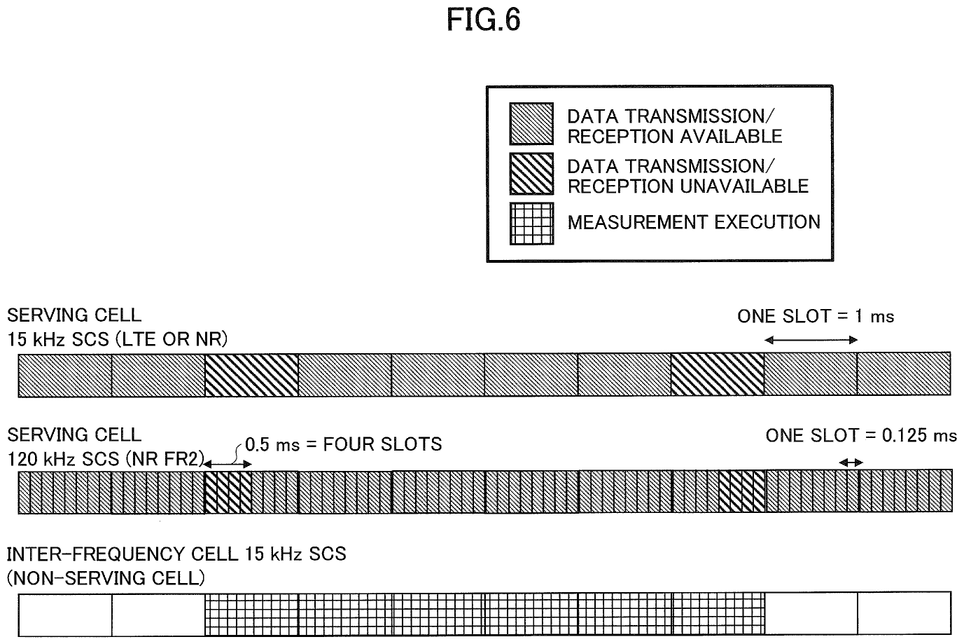

FIG. 6 is a diagram illustrating an example (1) of measurement according to the embodiment of the present invention. FIG. 6 illustrates an example in which gapless inter-frequency measurement is executed in per-UE gap and between synchronous cells.

As illustrated in FIG. 6, in regard to the slots of the serving cell corresponding to the 0.5 ms head of the measurement execution interval and the slots of the serving cell corresponding to the 0.5 ms tail of the measurement execution interval, interruption may be set to occur in units of slots. In the serving cell with 15 kHz SCS, interruption may be set to occur at a first slot and at a last slot. In the serving cell with 120 kHz SCS, interruption may set to occur in each of the four front slots and in each of the four back slots.

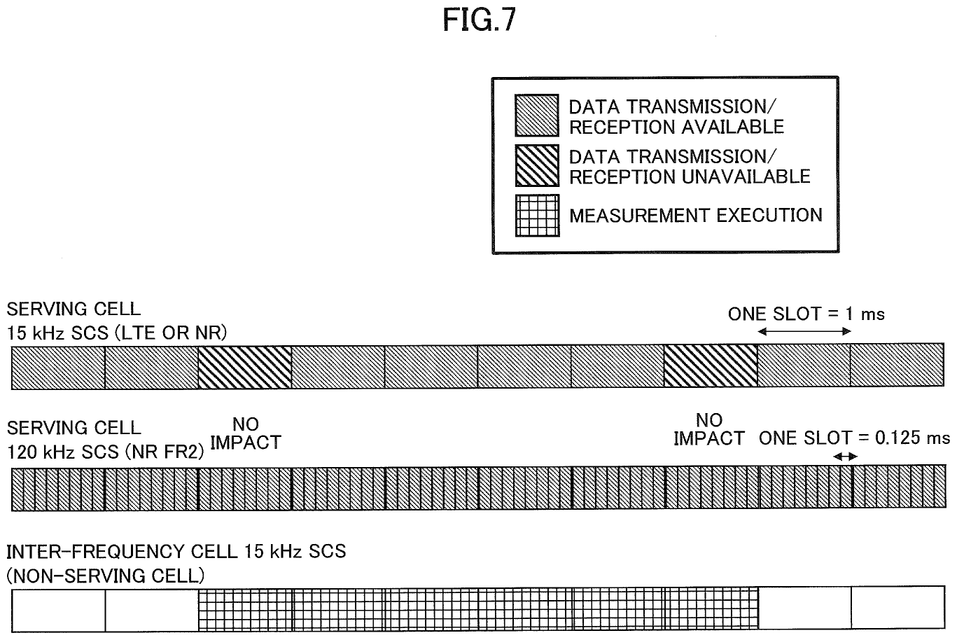

FIG. 7 is a diagram illustrating an example (2) of measurement according to the embodiment of the present invention. FIG. 7 is an example illustrating a gapless inter-frequency measurement executed in per-FR gap and between asynchronous cells.

As illustrated in FIG. 7, in regard to the slots of the serving cell corresponding to the 0.5 ms head of the measurement execution interval and the slots of the serving cell corresponding to the 0.5 ms tail of the measurement execution interval, interruption may be set to occur in units of slots. In the serving cell with 15 kHz SCS, interruption may be set to occur at a slot in the front and at a slot in the back. In contrast to this, since the serving cell with 120 kHz SCS is in FR2, interruption does not occur, and thus data transmission and reception can be performed without being impacted.

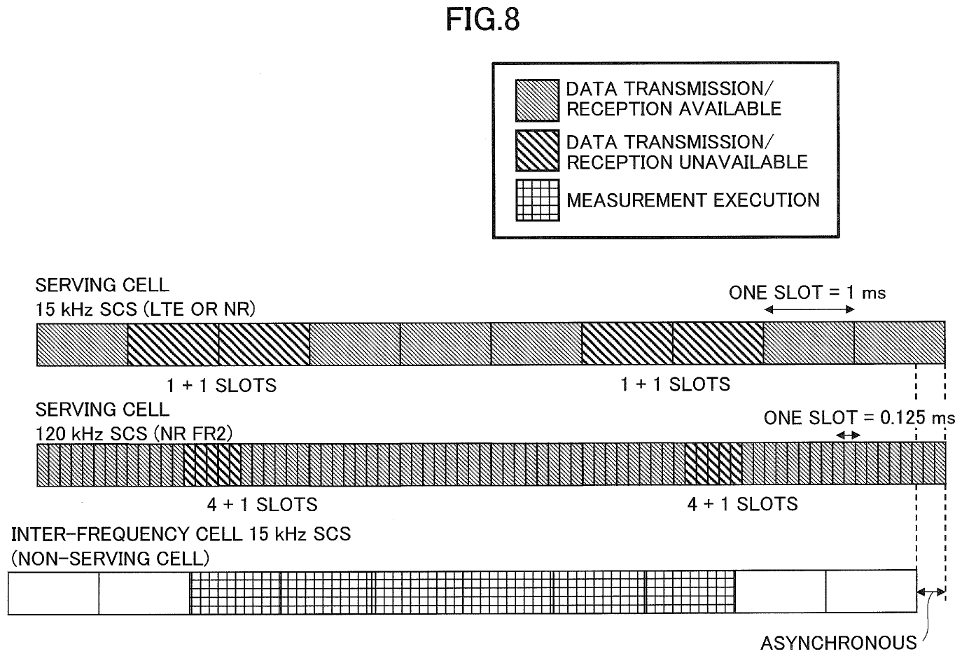

FIG. 8 is a diagram illustrating an example (3) of measurement according to the embodiment of the present invention. FIG. 8 illustrates an example in which gapless inter-frequency measurement is executed in per-UE gap and between asynchronous cells.

As illustrated in FIG. 8, in regard to the slots of the serving cell corresponding to the 0.5 ms head of the measurement execution interval and the slots of the serving cell corresponding to the 0.5 ms tail of the measurement execution interval, interruption may be set to occur in units of slots. In the serving cell with 15 kHz SCS, interruptions may be set to occur in two slots in the front and in two slots in the back, which is an increase by one slot in the front and by one slot in the back as compared with FIG. 6. In the serving cell with 120 kHz SCS, interruptions may be configured so as to occur in five slots in the front and in five slots in the back, which is an increase by one slot in the front and by one slot in the back as compared with FIG. 6.

The increased interruptions in the case of asynchronization illustrated in FIG. 8 so as to be greater in number by one slot than in the case of where there is synchronization as illustrated in FIG. 6, the respective interruptions can encompass the time needed for RF tuning (0.5 ms or 0.25 ms).

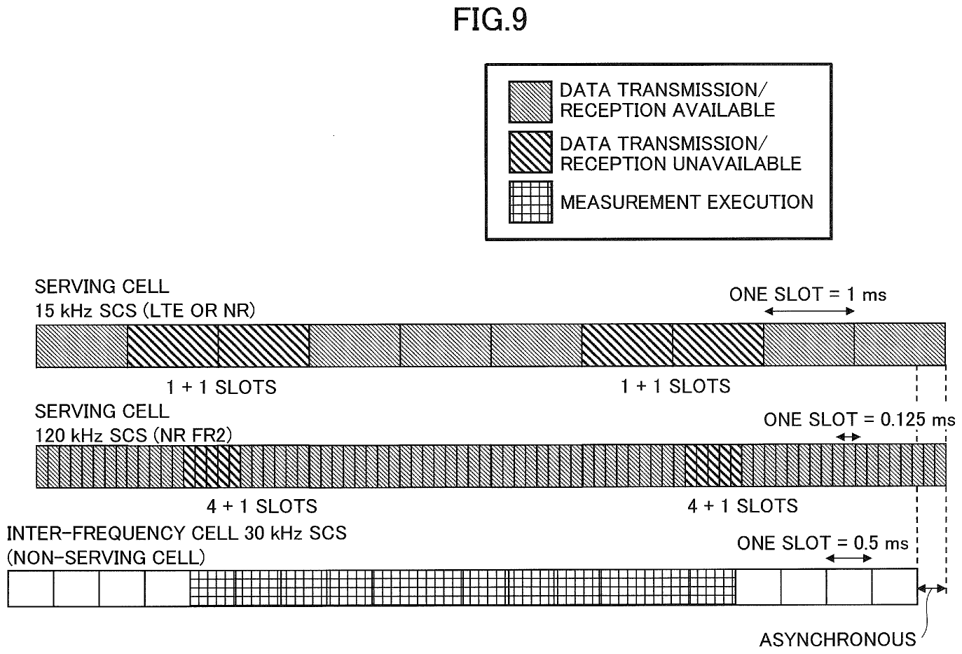

FIG. 9 is a diagram illustrating an example (4) of measurement according to the embodiment of the present invention. FIG. 9 illustrates an example of gapless inter-frequency measurement executed in per-UE gap and between asynchronous cells.

As illustrated in FIG. 9, in regard to the slots of the serving cell corresponding to the 0.5 ms head of the measurement execution interval and the slots the serving cell corresponding to the 0.5 ms tail of the measurement execution interval, interruption may be configured so as to occur in units of slots. In the serving cell with 15 kHz SCS, interruptions may be set to occur in two slots in the front and in two slots in the back, which is an increase by one slot in the front and by one slot in the back as compared with FIG. 6. In the serving cell with 120 kHz SCS, interruptions may be configured so as to occur in five slots in the front and in five slots in the back, which is an increase by one slot in the front and by one slot in the back as compared with FIG. 6.

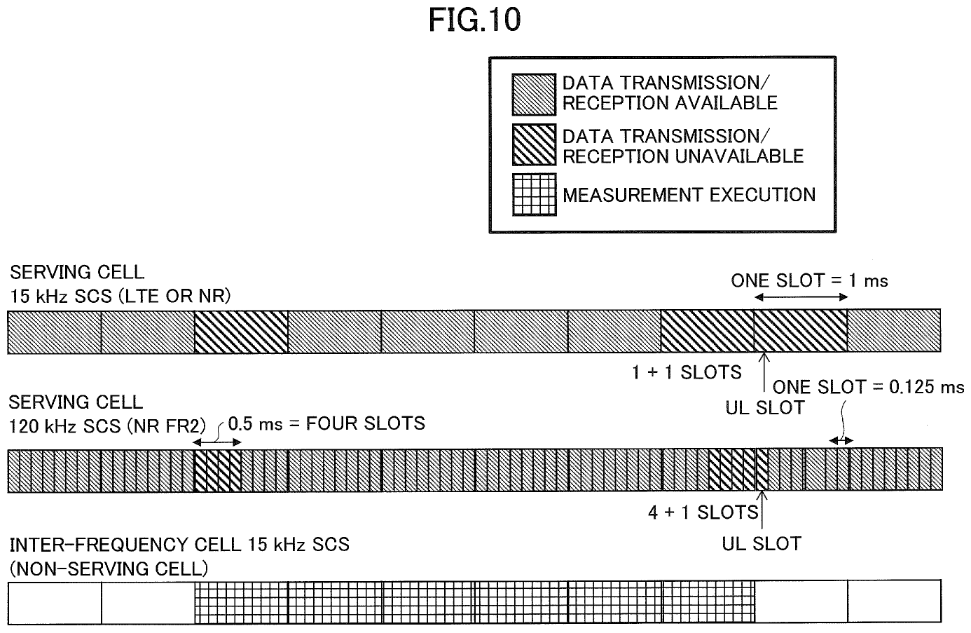

FIG. 10 is a diagram illustrating an example (5) of measurement according to the embodiment of the present invention. FIG. 10 illustrates an example in which gapless inter-frequency measurement is executed in per-UE gap and between asynchronous cells, and the slot coming immediately after the measurement execution interval is a UL slot.

As illustrated in FIG. 10 in regard to the slots of the serving cell corresponding to the 0.5 ms head of the measurement execution interval and the slots of the serving cell corresponding to the 0.5 ms tail of the measurement execution interval, interruption may be set to occur in units of slots. In the serving cell with 15 kHz SCS, the interruption may be set to occur in the first slot at the head of the measurement execution interval. Since the UL slot comes immediately after the measurement execution interval, the one slot at the tail of the measurement execution interval may be increased such that interruption occurs in two slots. In the serving cell with 120 kHz SCS, the interruption may be configured so as to occur in the five slots at the head of the measurement execution interval. Since the UL slot comes immediately after the measurement execution interval, the tail of the measurement execution interval may be increased by one slot such that interruption occurs in five slots. Since the UL slot comes immediately after the measurement execution interval, the tail of the measurement execution interval may be increased by one slot such that interruption occurs in five slots.

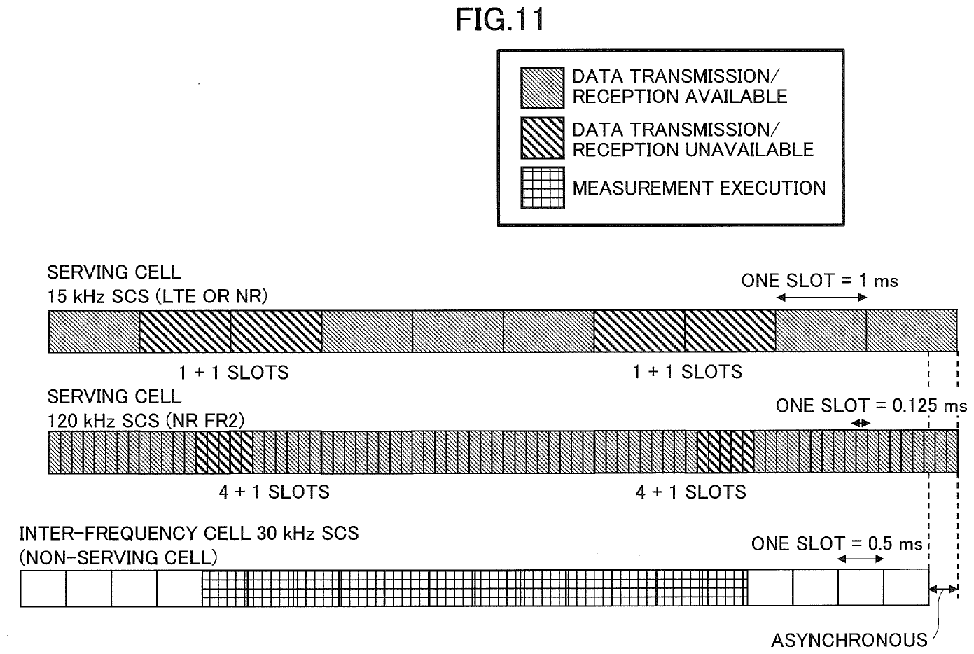

FIG. 11 is a diagram illustrating an example (6) according to the embodiment of the present invention. In FIG. 11, gapless inter-frequency measurement is executed in per-UE gap and between asynchronous cells, and the slot coming immediately after the measurement execution interval is a UL slot.

As illustrated in FIG. 11, in regard to the slots of the serving cell corresponding to the 0.5 ms head of the measurement execution interval and the slots of the serving cell corresponding to 0.5 ms tail of the measurement execution interval, interruption may be set to occur in units of slots. In the serving cell with 15 kHz SCS, in a case where one slot at the head and one slot at the tail of the measurement execution interval are asynchronous and a UL slot comes immediately after the measurement execution interval, the interruption may be increased so as to occur in two slots apiece. In a case where a UL slot comes immediately after the measurement execution interval between asynchronous cells, the interruption may be further extended by one slot.

In the serving cell with 120 kHz SCS, in a case where one slot at the head and at the tail of the measurement execution interval is asynchronous and a UL slot comes immediately after the measurement execution interval, interruption may be set to occur in five slots by increasing the number of slots by one. If a UL slots comes immediately after the measurement execution interval between asynchronous cells, the interruptions may be further extended by one slot.

According to the above-described embodiment examples, the terminal 20 can execute measurements using interruptions corresponding to the UE capability as well as communication conditions or the conditions of the cell targeted for measurement, and the like.

That is, in the radio communication system, inter-frequency measurement during a communication interruption period that is to be configured by the terminal 20 in accordance with an environment can be executed.

### <Apparatus Configuration>

Next, an example of functional configuration of the base station 10 and the terminal 20 that execute the processing and operations described so far will be described. The base station 10 and the terminal 20 include a function for implementing the above-described embodiment. However, each of the base station 10 and the terminal 20 may have only some of the functions in the embodiment.

### <Base Station 10>

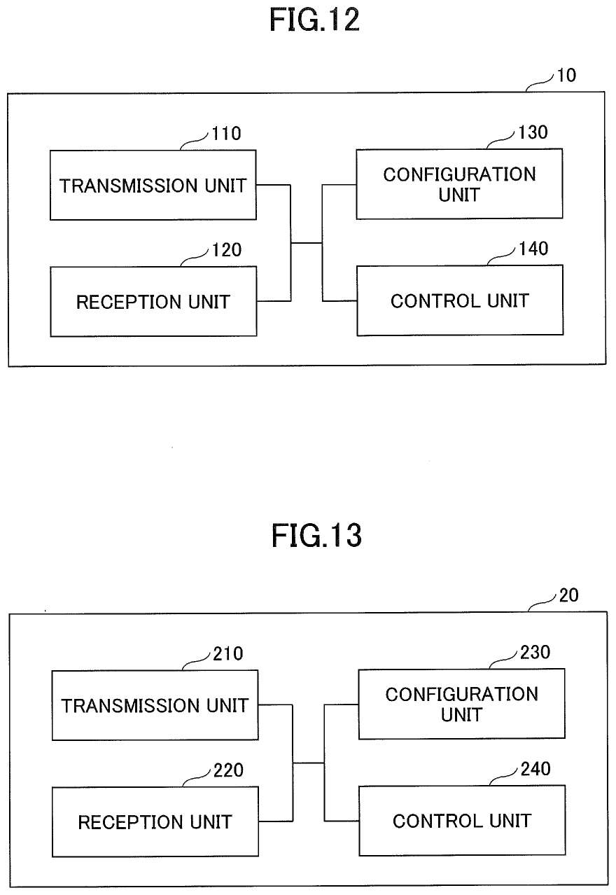

FIG. 12 is a diagram illustrating an example of a functional configuration of the base station 10. As illustrated in FIG. 12, the base station 10 includes a transmission unit 110, a reception unit 120, a configuration unit 130, and a control unit 140. The functional configuration illustrated in FIG. 12 is only an example. As long as the operation according to the embodiment of the present invention can be executed, the functions may be divided in any way, and the functional units may be given any names.

The transmission unit 110 includes a function of generating signals to be transmitted to the terminal 20 and wirelessly transmitting the signals. Also, the transmission unit 110 transmits an inter-network node message to another network node. The reception unit 120 includes a function of receiving various types of signals transmitted from the terminal 20 and acquiring, for example, information on a higher layer from the received signals. Further, the transmission unit 110 has a function of transmitting NR-PSS, NR-SSS, NR-PBCH, a DL/UL control signal, or the like to the terminal 20.

The configuration unit 130 stores configuration information configured in advance and various configuration information to be transmitted to the terminal 20 in the storage device, and reads from the storage device as necessary. The contents of the configuration information include, for example, a configuration regarding measurement in the terminal 20.

As described in the embodiment, the control unit 140 determines information for configuring a measurement in the terminal 20. Also, the control unit 140 performs configurations for measurement in the terminal 20. A functional unit configured to transmit signals in the control unit 140 may be included in the transmission unit 110, and a functional unit configured to receive signals in the control unit 140 may be included in the reception unit 120.

### <Terminal 20>

FIG. 13 is a diagram illustrating an example of a functional configuration of the terminal 20. As illustrated in FIG. 13, the terminal 20 includes a transmission unit 210, a reception unit 220, a configuration unit 230, and a control unit 240. The functional configuration illustrated in FIG. 13 is merely an example. As long as the operation according to the embodiment of the present invention can be executed, the functions may be divided in any way, and the function units may be given any names.

The transmission unit 210 generates a transmission signal from transmission data and wirelessly transmit the transmission signal. The reception unit 220 wirelessly receives various types of signals, and acquires a signal in a higher-layer from the received signal in the physical layer. Also, the reception unit 220 has a function of receiving NR-PSS, NR-SSS, NR-PBCH, DL/UL/SL control signals, reference signals, and the like that are transmitted from the base station 10. Also, for example, in D2D communication, the transmission unit 210 transmits, to another terminal 20, a PSCCH (Physical Sidelink Control Channel), a PSSCH (Physical Sidelink Shared Channel), a PSDCH (Physical Sidelink Discovery Channel), a PSBCH (Physical Sidelink Broadcast Channel), and the like. The reception unit 220 receives the PSCCH, the PSSCH, the PSDCH, the PSBCH, and the like, from the another terminal 20.

The configuration unit 230 stores various types of configuration information received from the base station 10 or the terminal 20 by the reception unit 220. The configuration unit 230 also stores configuration information configured in advance. The contents of the configuration information include, for example, configuration regarding measurement in the terminal 20.

As described in the embodiment, the control unit 240 executes the measurement set by the base station 10 and indicates the measurement result to the base station 10. A functional unit configured to transmit signals in the control unit 240 may be included in the transmission unit 210, and a functional unit configured to receive signals in the control unit 240 may be included in the reception unit 220.

### <Hardware Configuration>

The block diagrams (FIGS. 12 and 13) used for describing the above embodiments illustrate blocks in units of functions. These functional blocks (constituting units) are implemented by any combinations of at least one of hardware and software. In this regard, a method for implementing the various functional blocks is not particularly limited. That is, each functional block may be implemented by one device united physically and logically. Alternatively, each functional block may be implemented by connecting directly or indirectly (for example, in a wired or wireless manner) two or more devices that are physically or logically separated and connected together and using these multiple devices. The functional block may be implemented by combining software with the single device or multiple devices.

Functions include, but are not limited to, determining, calculating, processing, deriving, investigating, searching, confirming, receiving, transmitting, outputting, accessing, resolving, selecting, establishing, comparing, assuming, expecting, considering, broadcasting, notifying, communicating, forwarding, configuring, reconfiguring, allocating, mapping, assigning, and the like. For example, a functional block (constituting unit) that has a function of transmitting is referred to as a transmission unit or a transmitter. As described above, a method for implementing these functions is not particularly limited.

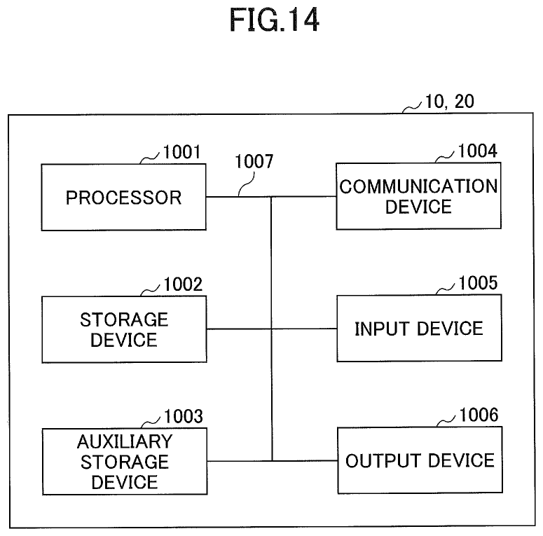

For example, the base station 10, the terminal 20, and the like according to one embodiment of the present disclosure may function as a computer that performs processing of a wireless communication according to the present disclosure. FIG. 14 is a diagram illustrating an example of a hardware configuration of the base station 10 or the terminal according to an embodiment of the present disclosure. Each of the base station 10 and terminal 20 may be physically configured as a computer device including a processor 1001, a storage device 1002, an auxiliary storage device 1003, a communication device 1004, an input device 1005, an output device 1006, a bus 1007, and the like.

It is noted that, in the following description, the term “device” may be read as a circuit, an apparatus, a unit, or the like. The hardware configurations of the base station 10 and the terminal 20 may be configured to include one or more of the devices illustrated in drawings, or may be configured not to include some of the devices.

Each function of the base station 10 and the terminal 20 may be implemented by reading predetermined software (program) to hardware such as the processor 1001, the storage device 1002, or the like, causing the processor 1001 to perform operations, controlling communication by the communication device 1004, and controlling at least one of reading and writing of data in the storage device 1002 and the auxiliary storage device 1003.

The processor 1001 executes, for example, an operating system to control the overall operation of the computer. The processor 1001 may be a central processing unit (CPU) including an interface with peripheral devices, a control device, an arithmetic device, a register, and the like. For example, the control unit 140, the control unit 240, and the like described above may be realized by the processor 1001.

The processor 1001 reads a program (program code), a software module, or data from at least one of the auxiliary storage device 1003 and the communication device 1004 onto the storage device 1002, and performs various processes according to the program, the software module, or the data. As the program, a program that causes a computer to perform at least some of the operations described in the embodiment described above is used. For example, the control unit 140 of the base station 10, as illustrated in FIG. 12, may be implemented by a control program that is stored in the storage device 1002 and that is executed by the processor 1001. Also, for example, the control unit 240 of the terminal 20, as illustrated in FIG. 13, may be implemented by a control program that is stored in the storage device 1002 and that is executed by the processor 1001. Explanation has been provided above for the case in which the above various processing are performed by the single processor 1001. However, such processing may be simultaneously or sequentially performed by two or more processors 1001. The processor 1001 may be implemented with one or more chips. It is noted that the program may be transmitted from a network through an electronic communication line.

The storage device 1002 is a computer-readable recording medium and may be constituted by at least one of, for example, a ROM (Read Only Memory), an EPROM (Erasable Programmable ROM), an EEPROM (Electrically Erasable Programmable ROM), a RAM (Random Access Memory), and the like. The storage device 1002 may also be referred to as a register, a cache, a main memory (main storage device), or the like. The storage device 1002 can store a program (program code), a software module and the like that can be executed to perform a communication method according to an embodiment of the present disclosure.

The auxiliary storage device 1003 is a computer-readable recording medium and may be configured by at least one of, for example, an optical disk such as a CD-ROM (Compact Disc ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and the like. The above storage medium may be, for example, a database, a server, or other appropriate media including at least one of the storage device 1002 and the auxiliary storage device 1003.

The communication device 1004 is hardware (a transmission and reception device) for performing communication between computers through at least one of a wired and wireless networks and may also be referred to as, for example, a network device, a network controller, a network card, a communication module, or the like. The communication device 1004 may include, for example, a radio frequency switch, a duplexer, a filter, a frequency synthesizer, or the like to implement at least one of a frequency division duplex (FDD) and a time division duplex (TDD). For example, a transmission and reception antenna, an amplifier, a transmitting and reception unit, a transmission line interface, and the like may be implemented by the communication device 1004. The transmitting and reception unit may be implemented in such a manner that a transmission unit and a reception unit are physically or logically separated.

The input device 1005 is an input device (for example, a keyboard, a mouse, a microphone, a switch, a button, a sensor, or the like) that receives an input from the outside. The output device 1006 is an output device (for example, a display, a speaker, an LED lamp, or the like) that performs an output to the outside. It is noted that the input device 1005 and the output device 1006 may be integrated with each other (for example, a touch panel).

The devices, such as the processor 1001 and the storage device 1002, are connected to each other via a bus 1007 for communicating information. The bus 1007 may be constituted by using a single bus, or may be constituted by using busses different depending on devices.

The base station 10 and the terminal 20 may include hardware, such as a microprocessor, a digital signal processor (DSP), an ASIC (Application Specific Integrated Circuit), a PLD (Programmable Logic Device), or an FPGA (Field Programmable Gate Array), or alternatively, some or all of the functional blocks may be implemented by the hardware. For example, the processor 1001 may be implemented with at least one of these hardware components.

### Summary of Embodiment

As described above, according to the embodiment of the present invention, provided is a terminal including a reception unit configured to receive a configuration regarding measurement from a base station, a control unit configurated to execute measurement based on the configuration regarding the measurement, and a transmission unit configured to transmit a result of the executed measurement to the base station, wherein the control unit is configured to identify a measurement execution interval based on the configuration regarding the measurement, and to configure a communication interruption period, at a head and a tail of the measurement execution interval, in accordance with a capability of the terminal.

According to the above configuration, the terminal 20 can execute measurement using interruptions corresponding to UE capability as well as communication conditions or conditions of the cell targeted for measurement, and the like. That is, in the radio communication system, inter-frequency measurement during a communication interruption period that is to be configured by the terminal in accordance with an environment can be executed.

In a case where the capability of the terminal is such that a measurement gap is separately configurable for each frequency range (FR), the control unit does not need to configure a communication interruption period in a cell in an FR other than a cell in an FR with which a communication interruption period is to be configured. According to the above configuration, the terminal 20 can execute measurement using interruptions corresponding to UE capability as well as communication conditions or conditions of the cell targeted for measurement, and the like.

In a case in which the capability of the terminal is such that a measurement gap that is the same in cells in a plurality of FR is to be configured, the control unit may configure a communication interruption period to be set in a cell in an FR with low frequency to a cell in another FR. According to the above configuration, the terminal 20 can execute measurement using interruptions corresponding to UE capability as well as communication conditions or conditions of the cell targeted for measurement, and the like.

In a case in which a serving cell and a cell that is targeted for measurement are asynchronous, the control unit may allow the communication interruption period to be extended. According to the above configuration, the terminal 20 can execute measurement using interruptions corresponding to UE capability as well as communication conditions or conditions of the cell targeted for measurement, and the like.

In a case in which a slot that comes immediately after the measurement execution interval is an uplink slot, the control unit may allow the communication interruption period to be extended. According to the above configuration, the terminal 20 can execute measurement using interruptions corresponding to UE capability as well as communication conditions or conditions of the cell targeted for measurement, and the like.

According to the above configuration of the present invention a communication method is provided causing a terminal to execute a reception procedure of receiving a configuration regarding measurement from a base station, a control procedure of executing a measurement based on the configuration regarding the measurement, and a transmission procedure of transmitting a result of the executed measurement to the base station, wherein, in the control procedure, a measurement execution interval is identified, by the terminal, based on the configuration regarding the measurement, and a communication interruption period is configured at a head and a tail of the measurement execution interval, by the terminal, in accordance with a capability of the terminal.

According to the above configuration, the terminal 20 can execute measurement using interruptions corresponding to UE capability as well as communication conditions or conditions of the cell targeted for measurement, and the like. That is, in the radio communication system, inter-frequency measurement during a communication interruption period that is to be configured by the terminal in accordance with an environment can be executed.

### Supplements to Embodiment

The embodiment of the present invention has been described above, but the disclosed invention is not limited to the above embodiment, and those skilled in the art would understand that various modified examples, revised examples, alternative examples, substitution examples, and the like can be made. In order to facilitate understanding of the present invention, specific numerical value examples are used for explanation, but the numerical values are merely examples, and any suitable values may be used unless otherwise stated. Classifications of items in the above description are not essential to the present invention, contents described in two or more items may be used in combination if necessary, and contents described in an item may be applied to contents described in another item (unless a contradiction arises). The boundaries between the functional units or the processing units in the functional block diagrams do not necessarily correspond to the boundaries of physical components. Operations of a plurality of functional units may be physically implemented by a single component and an operation of a single functional unit may be physically implemented by a plurality of components. Concerning the processing procedures described above in the embodiments, the orders of steps may be changed unless a contradiction arises. For the sake of convenience for describing the processing, the base station 10 and the terminal 20 have been described with the use of the functional block diagrams, but these apparatuses may be implemented by hardware, software, or a combination thereof. Each of software functioning with a processor of the base station 10 according to the embodiment of the present invention and software functioning with a processor of the terminal 20 according to the embodiment of the present invention may be stored in a random access memory (RAM), a flash memory, a read-only memory (ROM), an EPROM, an EEPROM, a register, a hard disk (HDD), a removable disk, a CD-ROM, a database, a server, or any suitable recording media.

Also, the notification of information is not limited to the aspect or embodiment described in the present disclosure, but may be performed by other methods. For example, the notification of information may be performed by physical layer signaling (for example, DCI (Downlink Control Information), UCI (Uplink Control Information)), higher layer signaling (for example, RRC (Radio Resource Control) signaling, MAC (Medium Access Control) signaling, broadcast information (an MIB (Master Information Block) and an SIB (System Information Block)), other signals, or combinations thereof. The RRC signaling may be also be referred to as an RRC message and may be, for example, an RRC connection setup message, an RRC connection reconfiguration message, or the like.

Each aspect and embodiment described in the present disclosure may be applied to at least one of a system that uses a suitable system such as LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (New Radio), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), or Bluetooth (registered trademark), and a next-generation system expanded on the basis thereof. Also, a plurality of systems may be combined and applied (for example, a combination of at least one of LTE and LTE-A with 5G, and the like).

In the operation procedures, sequences, flowcharts, and the like according to each aspect and embodiment described in the present disclosure, the orders of steps may be changed unless a contradiction arises. For example, in the methods described in the present disclosure, elements of various steps are illustrated by using an exemplary order and the methods are not limited to the specific orders presented.

The specific operations performed by the base station 10 described in the present disclosure may in some cases be performed by an upper node. It is clear that, in a network that includes one or more network nodes including the base station 10, various operations performed for communication with the terminal 20 can be performed by at least one of the base station 10 and another network node other than the base station 10 (for example, a MME, a S-GW, or the like may be mentioned, but not limited thereto). In the above, the description has been made for the case where another network node other than the base station 10 is a single node as an example. But the another network node may be a combination of a plurality of other network nodes (for example, a MME and a S-GW).

Information, signals, or the like described in the present disclosure may be output from a higher layer (or a lower layer) to a lower layer (or a higher layer). Information, signals, or the like described in the present disclosure may be input and output via a plurality of network nodes.

Information or the like that has been input or output may be stored at a predetermined place (for example, a memory) and may be managed with the use of a management table. Information or the like that is input or output can be overwritten, updated, or appended. Information or the like that has been output may be deleted. Information or the like that has been input may be transmitted to another apparatus.

In the present disclosure, determination may be made with the use of a value expressed by one bit (0 or 1), may be made with the use of a Boolean value (true or false), and may be made through a comparison of numerical values (for example, a comparison with a predetermined value).

Regardless of whether software is referred to as software, firmware, middleware, microcode, a hardware description language, or another name, software should be interpreted broadly to mean instructions, instruction sets, codes, code segments, program codes, a program, a sub-program, a software module, an application, a software application, a software package, a routine, a subroutine, an object, an executable file, an execution thread, a procedure, a function, and the like.

Software, instructions, information, or the like may be transmitted and received through transmission media. For example, in a case where software is transmitted from a website, a server or another remote source through at least one of wired technology (such as a coaxial cable, an optical-fiber cable, a twisted pair, or a digital subscriber line (DSL)) and radio technology (such as infrared or microwaves), at least one of the wired technology and the radio technology is included in the definition of a transmission medium.

Information, signals, and the like described in the present disclosure may be expressed with the use of any one of various different technologies. For example, data, instructions, commands, information, signals, bits, symbols, chips, and the like mentioned herein throughout the above explanation may be expressed by voltages, currents, electromagnetic waves, magnetic fields or magnetic particles, optical fields or photons, or any combinations thereof.

The terms described in the present disclosure and the terms necessary for understanding the present disclosure may be replaced with terms having the same or similar meanings. For example, at least one of a channel and a symbol may be a signal (signaling). A signal may be a message. A component carrier (CC) may be referred to as a carrier frequency, a cell, a frequency carrier, or the like.

The terms “system” and “network” used in the present disclosure are used interchangeably.

Information, parameters, and the like described in the present disclosure may be expressed by absolute values, may be expressed by relative values with respect to predetermined values, and may be expressed by corresponding different information. For example, radio resources may be indicated by indexes.

The above-described names used for the parameters are not restrictive in any respect. In addition, formulas or the like using these parameters may be different from those explicitly disclosed in the present disclosure. Various channels (for example, a PUCCH, a PDCCH, and the like) and information elements can be identified by any suitable names, and therefore, various names given to these various channels and information elements are not restrictive in any respect.

In the present disclosure, terms such as “base station (BS)”, “radio base station”, “base station apparatus”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like may be used interchangeably. A base station may be referred to as a macro-cell, a small cell, a femtocell, a pico-cell, or the like.

A base station can accommodate one or a plurality of (for example, three) cells (that may be called sectors). In a case where a base station accommodates a plurality of cells, the whole coverage area of the base station can be divided into a plurality of smaller areas. For each smaller area, a base station subsystem (for example, an indoor miniature base station RRH (Remote Radio Head)) can provide a communication service. The term “cell” or “sector” denotes all or a part of the coverage area of at least one of a base station and a base station subsystem that provides communication services in the coverage.

In the present disclosure, terms such as “mobile station (MS)”, “user terminal”, “user equipment (UE)”, and “terminal” may be used interchangeably.

By the person skilled in the art, a mobile station may be referred to as any one of a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, and other suitable terms.

At least one of a base station and a mobile station may be referred to as a transmitting apparatus, a receiving apparatus, a communication apparatus, or the like. At least one of a base station and a mobile station may be an apparatus mounted on a mobile body, or may be a mobile body itself, or the like. A mobile body may be a transporting device (e.g., a vehicle, an airplane, and the like), an unmanned mobile (e.g., a drone, an automated vehicle, and the like), or a robot (of a manned or unmanned type). It is noted that at least one of a base station and a mobile station includes an apparatus that does not necessarily move during a communication operation. For example, at least one of a base station and a mobile station may be an IoT (Internet of Thing) device such as a sensor.

In addition, a base station according to the present disclosure may be read as a user terminal. For example, each aspect or embodiment of the present disclosure may be applied to a configuration in which communication between a base station and a user terminal is replaced by communication between a plurality of terminals 20 (that may be called D2D (Device-to-Device), V2X (Vehicle-to-Everything), or the like). In this case, a terminal 20 may have above-described functions of the base station 10. In this regard, a word such as “up” or “down” may be read as a word corresponding to communication between terminals (for example, “side”). For example, an uplink channel, a downlink channel, or the like may be read as a side channel.

Similarly, a user terminal according to the present disclosure may be replaced with a base station. In this case, a base station may have above-described functions of the user terminal.

The term “determine” used herein may mean various operations. For example, judging, calculating, computing, processing, deriving, investigating, looking up, searching, inquiring (for example, looking up a table, a database, or another data structure), ascertaining, or the like may be deemed as making determination. Also, receiving (for example, receiving information), transmitting (for example, transmitting information), inputting, outputting, or accessing (for example, accessing data in a memory), or the like may be deemed as making determination. Also, resolving, selecting, choosing, establishing, comparing, or the like may be deemed as making determination. That is, doing a certain operation may be deemed as making determination. “To determine” may be read as “to assume”, “to expect”, “to consider”, or the like.

Each of the terms “connected” and “coupled” and any variations thereof mean any connection or coupling among two or more elements directly or indirectly and can mean that one or a plurality of intermediate elements are inserted among two or more elements that are “connected” or “coupled” together. Coupling or connecting among elements may be physical one, may be logical one, and may be a combination thereof. For example, “connecting” may be read as “accessing”. In a case where the terms “connected” and “coupled” and any variations thereof are used in the present disclosure, it may be considered that two elements are “connected” or “coupled” together with the use of at least one type of a medium from among one or a plurality of wires, cables, and printed conductive traces, and in addition, as some non-limiting and non-inclusive examples, it may be considered that two elements are “connected” or “coupled” together with the use of electromagnetic energy such as electromagnetic energy having a wavelength of the radio frequency range, the microwave range, or the light range (including both of the visible light range and the invisible light range).

A reference signal can be abbreviated as an RS (Reference Signal). A reference signal may be referred to as a pilot depending on an applied standard.

A term “based on” used in the present disclosure does not mean “based on only” unless otherwise specifically noted. In other words, a term “base on” means both “based on only” and “based on at least”.

Any references to elements denoted by a name including terms such as “first” or “second” used in the present disclosure do not generally limit the amount or the order of these elements. These terms can be used in the present disclosure as a convenient method for distinguishing one or a plurality of elements. Therefore, references to first and second elements do not mean that only the two elements can be employed or that the first element should be, in some way, prior to the second element.

“Means” in each of the above apparatuses may be replaced with “unit”, “circuit”, “device”, or the like.

In a case where any one of “include”, “including”, and variations thereof is used in the present disclosure, each of these terms is intended to be inclusive in the same way as the term “comprising”. Further, the term “or” used in the present disclosure is intended to be not exclusive-or.

A radio frame may include, in terms of time domain, one or a plurality of frames. Each of one or a plurality of frames may be referred to as a subframe in terms of time domain. A subframe may include, in terms of time domain, one or a plurality of slots. A subframe may have a fixed time length (e.g., 1 ms) independent of Numerology.

Numerology may be a communication parameter that is applied to at least one of transmission and reception of a signal or a channel. Numerology may mean, for example, at least one of a subcarrier spacing (SCS), a bandwidth, a symbol length, a cyclic prefix length, a transmission time interval (TTI), the number of symbols per TTI, a radio frame configuration, a specific filtering processing performed by a transceiver in frequency domain, a specific windowing processing performed by a transceiver in time domain, and the like.

A slot may include, in terms of time domain, one or a plurality of symbols (OFDM (Orthogonal Frequency Division Multiplexing) symbols, SC-FDMA (Single Carrier Frequency Division Multiplexing) symbols) symbols, or the like). A slot may be a time unit based on Numerology.

A slot may include a plurality of minislots. Each minislot may include one or a plurality of symbols in terms of the time domain. A minislot may also be referred to as a subslot. A minislot may include fewer symbols than a slot. A PDSCH (or PUSCH) transmitted at a time unit greater than a minislot may be referred to as a PDSCH (or PUSCH) mapping type A. A PDSCH (or PUSCH) transmitted using minislots may be referred to as a PDSCH (or PUSCH) mapping type B.

Each of a radio frame, a subframe, a slot, a minislot, and a symbol means a time unit configured to transmit a signal. Each of a radio frame, a subframe, a slot, a minislot, and a symbol may be referred to as other names respectively corresponding thereto.

For example, one subframe may be referred to as a transmission time interval (TTI), a plurality of consecutive subframes may be referred to as a TTI, and one slot or one minislot may be referred to as a TTI. That is, at least one of a subframe and a TTI may be a subframe (1 ms) according to the existing LTE, may have a period shorter than 1 ms (e.g., 1 to 13 symbols), and may have a period longer than 1 ms. Instead of subframes, units expressing a TTI may be referred to as slots, minislots, or the like.

A TTI means, for example, a minimum time unit of scheduling in radio communication. For example, in an LTE system, a base station performs scheduling for each terminal 20 to assign, in TTI units, radio resources (such as frequency bandwidths, transmission power, and the like that can be used by each terminal 20). However, the definition of a TTI is not limited thereto.

A TTI may be a transmission time unit for channel-coded data packets (transport blocks), code blocks, code words, or the like, and may be a unit of processing such as scheduling, link adaptation, or the like. When a TTI is given, an actual time interval (e.g., the number of symbols) to which transport blocks, code blocks, code words, or the like are mapped may be shorter than the given TTI.

In a case where one slot or one minislot is referred to as a TTI, one or a plurality of TTIs (i.e., one or a plurality of slots or one or a plurality of minislots) may be a minimum time unit of scheduling. The number of slots (the number of minislots) included in the minimum time unit of scheduling may be controlled.

A TTI having a time length of 1 ms may referred to as an ordinary TTI (a TTI according to LTE Rel.8-12), a normal TTI, a long TTI, an ordinary subframe, a normal subframe, a long subframe, a slot, or the like. A TTI shorter than an ordinary TTI may be referred to as a shortened TTI, a short TTI, a partial or fractional TTI, a shortened subframe, a short subframe, a minislot, a subslot, a slot, or the like.

Note that a long TTI (for example, normal TTI, subframe, and the like) may be read as TTI having a time length exceeding 1 ms, and a short TTI (for example, shortened TTI) may be read as a TTI having a TTI length less than the TTI length of the long TTI and equal to or more than 1 ms.

A resource block (RB) is a resource assignment unit in terms of time domain and frequency domain and may include one or a plurality of consecutive subcarriers in terms of frequency domain. The number of subcarriers included in an RB may be the same regardless of Numerology, and, for example, may be 12. The number of subcarriers included in a RB may be determined based on Numerology.

In terms of time domain, an RB may include one or a plurality of symbols, and may have a length of 1 minislot, 1 subframe, or 1 TTI. Each of 1 TTI, 1 subframe, and the like may include one or a plurality of resource blocks.

One or a plurality of RBs may be referred to as physical resource blocks (PRBs: Physical RBs), a subcarrier group (SCG: Sub-Carrier Group), a resource element group (REG: Resource Element Group), a PRB pair, an RB pair, or the like.

A resource block may include one or a plurality of resource elements (RE: Resource Elements). For example, 1 RE may be a radio resource area of 1 subcarrier and 1 symbol.

A bandwidth part (BWP) (which may be called a partial bandwidth or the like) may mean a subset of consecutive common RBs (common resource blocks) for Numerology, in any given carrier. A common RB may be identified by a RB index with respect to a common reference point in the carrier. PRBs may be defined by a BWP and may be numbered in the BWP.

A BWP may include a BWP (UL BWP) for UL and a BWP (DL BWP) for DL. For a UE, one or a plurality of BWPs may be set in 1 carrier.

At least one of BWPs that have been set may be active, and a UE need not assume sending or receiving a predetermined signal or channel outside the active BWP. A “cell”, a “carrier” or the like in the present disclosure may be read as a “BWP”.

The above-described structures of radio frames, subframes, slots, minislots, symbols, and the like are merely examples. For example, the number of subframes included in a radio frame, the number of slots included in a subframe or a radio frame, the number of minislots included in a slot, the number of symbols and the number of RBs included in a slot or a minislot, the number of subcarriers included in an RB, the number of symbols included in a TTI, a symbol length, a cyclic prefix (CP) length, and the like can be variously changed.

Throughout the present disclosure, in a case where an article such as “a”, “an”, or “the” in English is added through a translation, the present disclosure may include a case where a noun following such article is of a plural form.

Throughout the present disclosure, an expression that “A and B are different” may mean that “A and B are different from each other”. Also, this term may mean that “each of A and B is different from C”. Terms such as “separate” and “coupled” may also be interpreted in a manner similar to “different”.

Each aspect or embodiment described in the present disclosure may be solely used, may be used in combination with another embodiment, and may be used in a manner of being switched with another embodiment upon implementation. Notification of predetermined information (for example, notification of “being x”) may be implemented not only explicitly but also implicitly (for example, by not notifying predetermined information).

In the present disclosure, the term “MeasObjectNR” is an example of a configuration regarding measurement. Interruption is an example of a communication interruption period.

Although the present disclosure has been described above, it will be understood by those skilled in the art that the present disclosure is not limited to the embodiment described in the present disclosure. Modifications and changes of the present disclosure may be possible without departing from the subject matter and the scope of the present disclosure defined by claims. Therefore, the descriptions of the present disclosure are for illustrative purposes only, and are not intended to be limiting the present disclosure in any way.

### REFERENCE SIGNS LIST

10 base station
110 transmission unit
120 reception unit
130 configuration unit
140 control unit
20 terminal
210 transmission unit
220 reception unit
230 configuration unit
240 control unit
1001 processor
1002 storage device
1003 auxiliary storage device
1004 communication apparatus
1005 input device
1006 output device

1. A terminal comprising:
a reception unit configured to receive a configuration regarding measurement from a base station;
a control unit configurated to execute measurement based on the configuration regarding the measurement; and
a transmission unit configured to transmit a result of the executed measurement to the base station,
wherein the control unit is configured to identify a measurement execution interval based on the configuration regarding the measurement, and to configure a communication interruption period, at a head and a tail of the measurement execution interval, in accordance with a capability of the terminal.

2. The terminal according to claim 1, wherein in a case in which the capability of the terminal is such that a measurement gap is separately configurable for each frequency range (FR), the control unit is configured to refrain from configuring a communication interruption period in a cell in an FR other than a cell in an FR with which a communication interruption period is to be configured.

3. The terminal according to claim 1, wherein in a case in which the capability of the terminal is such that a measurement gap that is the same in cells in a plurality of FR is to be configured, the control unit is configured to configure a communication interruption period to be configured in a cell in an FR with low frequency to a cell in another FR.

4. The terminal according to claim 1, wherein in a case in which a serving cell and a cell that is targeted for measurement are asynchronous, the control unit is configured to allow the communication interruption period to be extended.

5. The terminal according to claim 1, wherein in a case in which a slot that comes immediately after the measurement execution interval is an uplink slot, the control unit is configured to allow the communication interruption period to be extended.

6. A communication method causing a terminal to execute:
a reception procedure of receiving a configuration regarding measurement from a base station;
a control procedure of executing a measurement based on the configuration regarding the measurement; and
a transmission procedure of transmitting a result of the executed measurement to the base station,
wherein, in the control procedure, a measurement execution interval is identified, by the terminal, based on the configuration regarding the measurement, and a communication interruption period is configured at a head and a tail of the measurement execution interval, by the terminal, in accordance with a capability of the terminal.
